(19) United States
(12) Patent Application Publication
(10) Pub. No.: US 2009/0106934 A1
(43) Pub. Date: Apr. 30, 2009

(54) Vehicle Closure Check Link

(75) Inventors: Houng Yue Chang, Canton, MI (US); Brian Lardie, II, Lincoln Park, MI (US); Paul R. Meernik, Redford, MI (US); Ronald P. McKenney, Troy, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/930,257

(22) Filed: Oct. 31, 2007

(51) Int. Cl. E05F 5/00

(52) U.S. Cl. 16/84

(57) ABSTRACT

A check link for a closure of a vehicle pivotally connected to vehicle structure, and a method of operation, are disclosed. The check link may include a main rod having a first end pivotally engaging one of the vehicle structure and the closure, and an end cap fixed to an opposed second end. A support may be mounted on the other of the vehicle structure and the closure, with the main rod extending through the support. Also, a shock absorber is mounted to the support and located between the end cap and the support. The shock absorber is configured to absorb energy of motion of the closure when compressed between the end cap and the support.

### BACKGROUND OF INVENTION

The present invention relates generally to vehicle closures, and more particularly to check links for vehicle closures.

Check links are employed with vehicle closures, such as, for example, side doors that pivot open. The check links stop the movement of the door when swung to its full open position-absorbing the kinetic energy of the door in order to stop it. Accordingly, when a door is swung open quickly, the check link, and the components to which it is attached, are subjected to a high peak impact load (check load) right at the end of travel. The check link, and the components to which it is attached-for example, a door pillar and a door panel-must be sized to repeatedly absorb this high peak load over the life of the vehicle.

### SUMMARY OF INVENTION

An embodiment contemplates a check link for a closure of a vehicle pivotally connected to vehicle structure. The check link may comprise a main rod having a first end configured to pivotally engage one of the vehicle structure and the closure, and an opposed second end; an end cap fixed to the opposed second end; a support mounted on the other of the vehicle structure and the closure, the main rod extending through the support; and a shock absorber mounted to the support and located between the end cap and the support, the shock absorber configured to absorb energy of motion of the closure when compressed between the end cap and the support.

An embodiment contemplates a check link for a closure of a vehicle pivotally connected to vehicle structure. The check link may comprise a main rod having a first end configured to pivotally engage one of the vehicle structure and the closure, and an opposed second end; an end cap fixed to the opposed second end; and a pneumatic shock absorber located between the end cap and the other of the vehicle structure and the closure, the shock absorber including an air chamber and a vent hole from the air chamber configured to control flow between the chamber and atmosphere, the shock absorber configured to resiliently absorb energy of motion of the closure when compressed.

An embodiment contemplates a method of absorbing energy of movement of a closure pivotable relative to a vehicle body as the closure approaches an end of movement location, the method comprising the steps of: allowing free pivoting movement over a first portion of travel of the closure; engaging a pneumatic shock absorber over a second portion of closure travel adjacent to the end of movement location; increasing air pressure in the pneumatic shock absorber over the second portion of closure travel to absorb the energy of movement of the closure; and relieving a portion of the air pressure in the pneumatic shock absorber over the second portion of travel.

An advantage of an embodiment is that the closure check link will absorb the closure opening energy over a greater amount of travel, thus reducing the peak load absorbed by the check link and vehicle structure. By reducing the peak load, the reinforcements needed in the vehicle and closure structure to support the check link load can be reduced. This reduces the weight of the vehicle and closure structure in these locations.

An advantage of an embodiment is that the check link may also function as a hold open device for the closure.

An advantage of an embodiment is that the check link, by slowing the motion of the closure leading up to the full open position and thus reducing the impact at the end of travel, may create a perception of a higher quality closure/vehicle.

### BRIEF DESCRIPTION OF DRAWINGS

FIG. 1 is a perspective view of a portion of a vehicle.

FIG. 2 is a partially-exploded, perspective view of a check link, and portions of a vehicle body and closure.

FIG. 3 is a schematic, elevation view, on an enlarged scale, of a check link according to a second embodiment.

FIG. 4 is a schematic, perspective view, on an enlarged scale, of a subassembly of the check link of FIG. 3.

FIG. 5 is a view similar to FIG. 3, but illustrating a third embodiment of the check link.

FIG. 6 is a view similar to FIG. 4, but illustrating the third embodiment.

FIG. 7 is a view similar to FIG. 3, but illustrating a fourth embodiment of the check link.

FIG. 8 is a schematic, perspective view of a portion of a check link illustrating a fifth embodiment.

### DETAILED DESCRIPTION

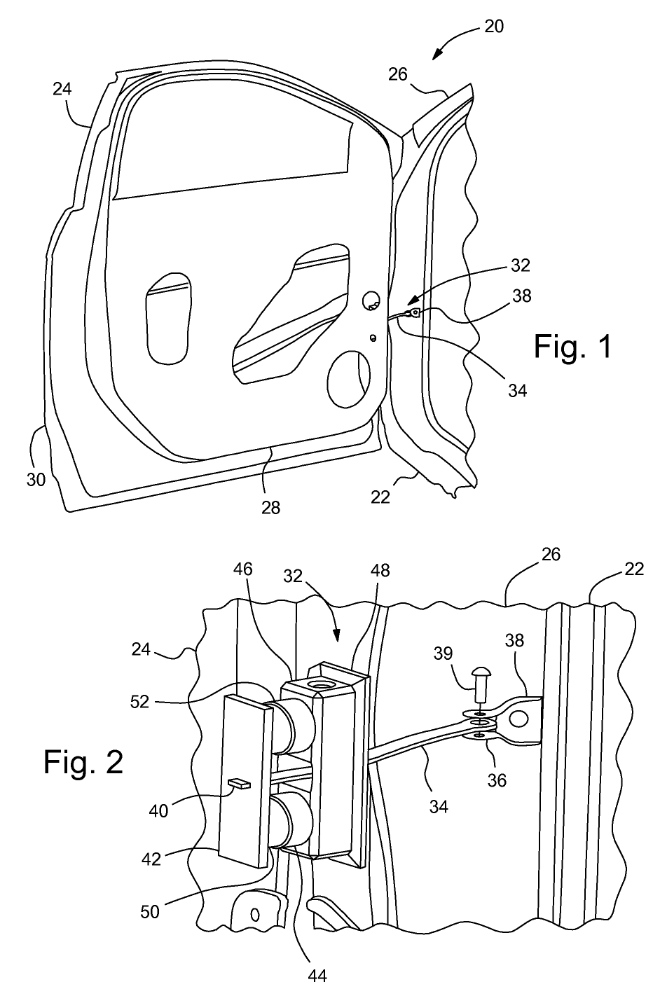

Referring to FIGS. 1 and 2, a vehicle, indicated generally at 20, is shown. The vehicle 20 includes a vehicle body (structure) 22 to which a closure 24 is pivotally mounted. The closure 24 may be, for example, a side door pivotally mounted to a vehicle A-pillar 26. While an example of a side door is shown, the present invention may be employed with other closures, such as, for example, a decklid (not shown) or a hood (not shown). The closure 24 may include a closure inner panel 28 and a closure outer panel 30, with a check link 32 mounted to one of these panels 28, 30.

The check link 32 includes a main rod 34, which has a fastener lug 36 at a first end that mounts to an attachment bracket 38 on the A-pillar 26 via a fastener 39. A second end 40 of the main rod 34 is secured to an end cap 42. The check link 32 also includes a pair of pneumatic shock absorbers 44 mounted between the end cap 42 and a support housing 46. The support housing 46 is attached to a mounting base 48, which is, in turn, mounted to the closure 24. The main rod 34 extends through the mounting base 48, support housing 46, and between the shock absorbers 44, and can slide relative to these components. As an alternative, the check link 32 may be reversed, with the first end mounted to the closure 24 and the second end interacting with a check link 32 mounted to vehicle structure, if so desired.

Each shock absorber 44 includes an inner air chamber cup 50 that slides telescopically inside and seals within an outer air chamber cup 52, forming an air chamber in each shock absorber 44. The outer air chamber cup 52 is mounted to the support housing 46. A helical, compressed spring (not shown in this embodiment) may be mounted in each of the shock absorbers 44. Also, while two shock absorbers 44 are shown, other numbers of shock absorbers may be employed, if so desired.

The operation of the check link 32 will now be described. When the closure 24 is closed, the end cap 42 is supported by the main rod 34 and is spaced from the shock absorbers 44. As the closure 24 begins to open, the closure pivots the mounting base 48, and, accordingly, the support housing 46 and shock absorbers 44, away from the first end of the main rod 34. As the closure 24 is close to its full open position, the inner air chamber cups 50 contact the end cap 42. With the main rod 34, and hence the end cap 42, attached to the vehicle body 22, the end cap 42 now begins to press each of the inner air chamber cups 50 into their respective outer air chamber cups 52, building up pneumatic pressure in each shock absorber 44. The pressure increase acts against the motion of the closure 24 to absorb the kinetic energy of the closure movement. Eventually, enough energy is absorbed that the closure 24 will stop in its full open position. By absorbing the energy over a longer portion of closure travel, the peak load will be lower. Also, some of the air in the air chambers may be allowed to escape during this final motion of the closure 24, which will be discussed in more detail with respect to the second embodiment.

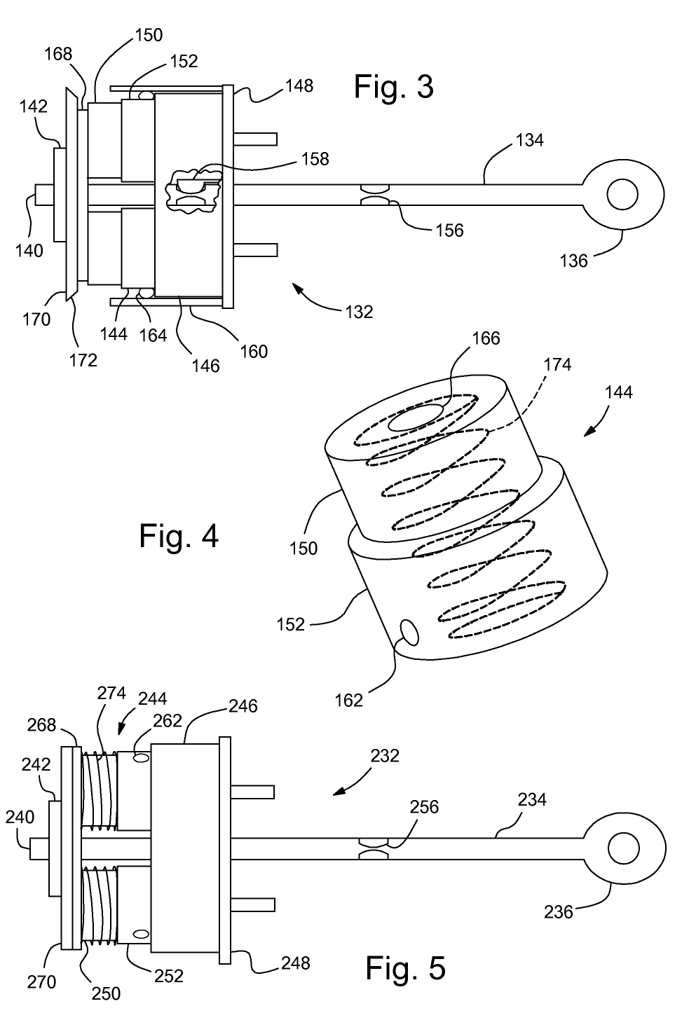

FIGS. 3 and 4 illustrate a second embodiment. Since this embodiment is similar to the first, similar element numbers will be used for similar elements, but employing 100-series numbers. A main rod 134 still includes a fastener lug 136 at a first end for pivotally securing to a vehicle body (not shown in this embodiment) and a second end 140 fixed to an end cap 142. This main rod 134 may also now include rod detents 156 that selectively align with a hold-open flange 158 mounted in the support housing 146. The hold-open flange 158 and detents 156 show one possible example for having intermediate hold-open positions for the closure (not shown in this embodiment), but they may take any form desired for maintaining the closure in various partially open positions.

The mounting base 148 includes leaf springs 160 extending along the support housing 146 and outer air chamber cups 152 of the shock absorbers 144. Each leaf spring 160 aligns with a corresponding outlet vent hole 162 through the corresponding outer air chamber cup 152. A vent plug 164 is mounted to each leaf spring 160, between each leaf spring 160 and its corresponding outlet vent hole 162. Each vent plug 164 is sized to be pressed into and seal its corresponding outlet venting hole 162 when its respective leaf spring 160 is in its unflexed state.

Each inner air chamber cup 150 includes an inlet vent hole 166 facing toward a sealing end plate 168. A lever arm 170 is mounted between the sealing end plate 168 and the end cap 142. The end cap 142, lever arm 170 and sealing end plate 168 preferably do not slide relative to the main rod 134. Accordingly, one may make the end cap 142, lever arm 170 and sealing end plate 168 into an integrated component, if so desired. The lever arm 170 includes an angled spring engagement surface 172. The spring engagement surface 172 is located so that it will contact the leaf springs 160 when pulled toward the support housing 146 by the main rod 134. The angle of the spring engagement surface 172, then, allows the lever arm 170 to pry the leaf springs 160 outward when these components come into contact.

The interior of each pneumatic shock absorber 144 also includes a coil spring 174 that biases the inner air chamber cup 150 away from the outer air chamber cup 152.

The operation of the check link 132 will now be described. When the closure is closed, the end cap 142, lever arm 170 and sealing end plate 168 are supported by the main rod 134 and spaced from the shock absorbers 144. In this position, the coil springs 174 will bias the inner air chamber cups 150 telescopically outward to their fully extended positions relative to the outer air chamber cups 152. Also, the inlet vent holes 166 will be open to atmosphere. The outlet vent holes 162 will be sealed closed by the bias of the leaf springs 160 pressing the vent plugs 164 into the outlet vent holes 162.

As the closure begins to open, the closure pivots the mounting base 148, and, accordingly, the support housing 146 and shock absorbers 144, away from the first end of the main rod 134. As the closure moves close to its full open position, the inner air chamber cups 150 contact the sealing end plate 168, closing the inlet vent holes 166. With the main rod 134, and hence the end cap 142 (and lever arm 170 and sealing end plate 168), attached to the vehicle body, the inner air chamber cups 150 are pressed into their respective outer air chamber cups 152, building up pneumatic pressure in each shock absorber 144 and compressing the springs 174. The pressure increase and spring bias acts against the motion of the closure to absorb the kinetic energy of the closure movement.

As the closure continues to move toward its fully open position, the spring engagement surfaces 172 of the lever arm 170 will contact the leaf springs 160. As the engagement surfaces 172 move further, they will pry the leaf springs 160 outward, which pulls the vent plugs 164 out of the outlet vent holes 162. This allows some of the air to escape from the shock absorbers 144 to atmosphere, relieving the pressure that has been building up. With the kinetic energy absorbed, the closure is stopped in its full open position. Again, by absorbing the energy over a longer portion of closure travel, the total energy of closure movement is absorbed, but the peak load is lower.

Also, as the closure closes, the sealing end plate 168 will again expose the inlet vent holes 166 allowing air to enter the shock absorbers 144, and the spring 174 will push the inner air chamber cups 150 outward relative to the outer air chamber cups 152. Thus, the check link 132 will be returned to its original position, ready for the next closure opening event.

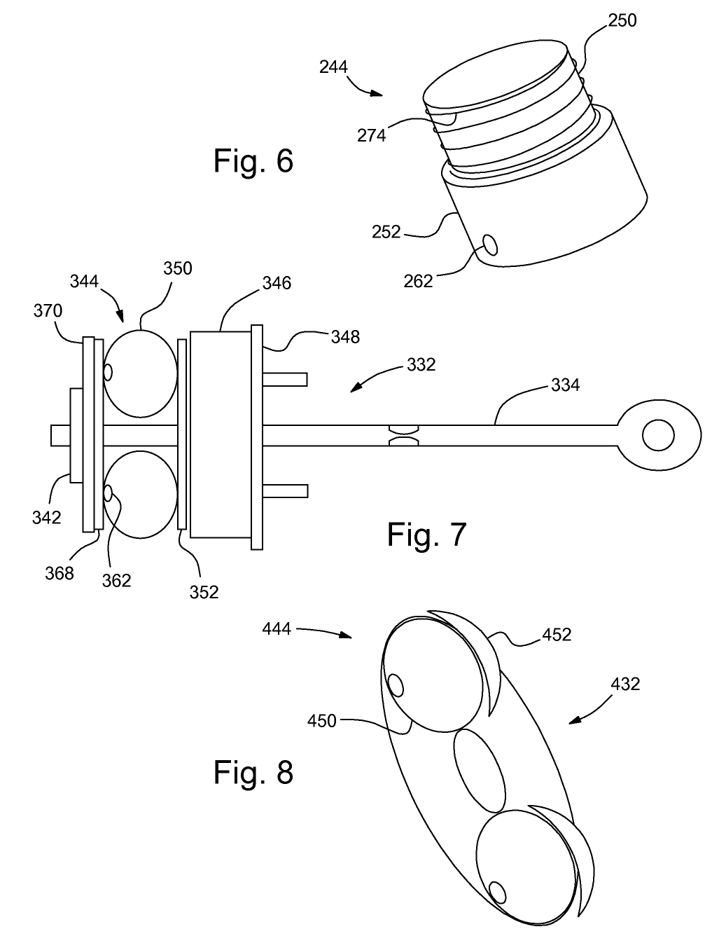

FIGS. 5 and 6 illustrate a third embodiment. Since this embodiment is similar to the second, similar element numbers will be used for similar elements, but employing 200-series numbers. A main rod 234 still includes a fastener lug 236 at a first end for securing to a vehicle body (not shown in this embodiment) and a second end 240 fixed to an end cap 242. This main rod 234 may include rod detents 256 that selectively align with a hold-open flange (not shown in this embodiment). A lever arm 270 is mounted between an end plate 268 and the end cap 242. The end cap 242, lever arm 270 and end plate 268 preferably do not slide relative to the main rod 234. Accordingly, one may make the end cap 242, lever arm 270 and end plate 268 into an integrated component, if so desired.

Each shock absorber 244 includes an inner piston 250 telescopically sliding in an outer air chamber cup 252. Each of the outer air chamber cups 252 is mounted to a support housing 246 and includes an inlet/outlet vent hole 262 located adjacent to the support housing 246. Each inner piston 250 has a coil spring 274 wrapped around it. The coil springs 274 are attached to their respective inner pistons 250 at an end adjacent to the end plate 268, with the opposite end pressing against the outer air chamber cup 252. Accordingly, the coil springs 274 bias the inner pistons telescopically away from their respective outer air chamber cups 252.

The operation of the check link 232 will now be described. When the closure is closed, the end cap 242, lever arm 270 and end plate 268 are supported by the main rod 234, spaced from the shock absorbers 244. In this position, the coil springs 274 will bias the inner pistons 250 telescopically outward to their fully extended positions relative to the outer air chamber cups 252.

As the closure begins to open, the closure pivots the mounting base 248, and, accordingly, the support housing 246 and shock absorbers 244, away from the first end of the main rod 234. As the closure moves close to its full open position, the inner pistons 250 contact the end plate 268. With the main rod 234, and hence the end cap 242 (and lever arm 270 and end plate 268), attached to the vehicle body, each of the inner pistons 250 are pressed into their respective outer air chamber cups 252, building up pneumatic pressure in each shock absorber 244 and compressing the springs 274. The pressure increase and spring bias acts against the motion of the closure to absorb the kinetic energy of the closure movement. The inlet/outlet vent holes 262 allow some of the air to escape from the shock absorbers 244 to atmosphere as they are being compressed, relieving some of the pressure that has been building up. The vent holes 262 are sized to limit the rate of outgoing air flow to assure that enough pressure builds up to absorb the kinetic energy of the closure. With the kinetic energy absorbed, the closure is stopped in its full open position. Again, by absorbing the energy over a longer portion of closure travel, the total energy of closure movement is absorbed, but the peak load is lower.

Also, as the closure closes, the end plate 268 will move away from the shock absorbers 244, allowing the springs 274 to expand the shock absorbers 244, while air enters through the vent holes 262. Thus, the check link 232 will be returned to its original position.

FIG. 7 illustrates a fourth embodiment. Since this embodiment is similar to the three previous embodiments, similar element numbers will be used for similar elements, but employing 300-series numbers. The main rod 334, support housing 346, mounting base 348, end cap 342, lever arm 370, and end plate 368 may be the same as in the third embodiment.

In this embodiment, the shock absorbers do not include telescoping cylinders. The pneumatic shock absorbers 344 include hollow elastic balloons 350 mounted between the end plate 368 and a support plate 352. The balloons 350 can be shaped like two balls, or, alternatively, may be other suitable shapes, such as a single torus. Each of the balloons 350 includes an inlet/outlet vent hole 362. As the closure approaches its full open position, the balloons 350 will be squeezed between the end plate 368 and the support plate 352. The vent holes 362 are sized to limit the rate of outgoing air flow to assure that enough pressure builds up to absorb the kinetic energy of the closure. With the kinetic energy absorbed, the closure is stopped in its full open position. Also, as the closure closes, the end plate 368 will move away from the shock absorbers 344, allowing the elastic balloons 350 to expand while air enters through the vent holes 362. Thus, the check link 332 will be returned to its original position.

FIG. 8 illustrates a fifth embodiment. Since this embodiment is similar to the fourth, similar element numbers will be used for similar elements, but employing 400-series numbers. This embodiment employs the elastic balloons 450 as part of the shock absorbers 444, but there are now two support plates 452—one supporting each balloon 450. The support plates 452 are curved to better support the balloons 450. The operation of the check link 432 is the same as in the fourth embodiment.

While certain embodiments of the present invention have been described in detail, those familiar with the art to which this invention relates will recognize various alternative designs and embodiments for practicing the invention as defined by the following claims.

What is claimed is:

1. A check link for a closure of a vehicle pivotally connected to vehicle structure, the check link comprising:
a main rod having a first end configured to pivotally engage one of the vehicle structure and the closure, and an opposed second end;
an end cap fixed to the opposed second end;
a support mounted on the other of the vehicle structure and the closure, the main rod extending through the support; and
a shock absorber mounted to the support and located between the end cap and the support, the shock absorber configured to absorb energy of motion of the closure when compressed between the end cap and the support.

2. The check link of claim 1 wherein the shock absorber includes an outer air chamber cup mounted to the support and an inner air chamber cup telescopically slidable in the outer air chamber cup, the outer air chamber cup and the inner air chamber cup defining an air chamber.

3. The check link of claim 2 wherein the shock absorber includes a spring mounted in the air chamber and configured to bias the inner air chamber cup telescopically outward from the outer air chamber cup.

4. The check link of claim 3 wherein the inner air chamber cup includes an inlet vent hole facing toward the end cap and the outer air chamber cup includes an outlet vent hole adjacent to the support, and wherein a lever arm is mounted to the end cap and a sealing end plate is mounted to the lever arm adjacent to the inlet vent hole, the lever arm including a spring engagement surface, and the support includes a leaf spring extending therefrom adjacent to the outlet vent hole, with a vent plug affixed to the leaf spring for selective sealing engagement with the outlet vent hole, the spring engagement surface configured to flex the leaf spring and thereby remove the vent plug from the outlet vent hole when the spring engagement surface is pulled into contact with the leaf spring.

5. The check link of claim 2 wherein the inner air chamber cup includes an inlet vent hole facing toward the end cap and the outer air chamber cup includes an outlet vent hole adjacent to the support, and wherein a lever arm is mounted to the end cap and a sealing end plate is mounted to the lever arm adjacent to the inlet vent hole, the lever arm including a spring engagement surface, and the support includes a leaf spring extending therefrom adjacent to the outlet vent hole, with a vent plug affixed to the leaf spring for selective sealing engagement with the outlet vent hole, the spring engagement surface configured to flex the leaf spring and thereby remove the vent plug from the outlet vent hole when the spring engagement surface is pulled into contact with the leaf spring.

6. The check link of claim 1 wherein the main rod includes a rod detent and the support includes a hold open flange configured to selectively engage the rod detent to thereby maintain the closure in a predetermined position.

7. The check link of claim 1 wherein the shock absorber includes an outer air chamber cup mounted to the support and an inner piston telescopically slidable in the outer air chamber cup, the outer air chamber cup and the inner piston defining an air chamber.

8. The check link of claim 7 wherein the shock absorber includes a spring mounted about the inner piston and configured to bias the inner piston telescopically outward from the outer air chamber cup.

9. The check link of claim 7 wherein the outer air chamber cup includes a vent hole therethrough.

10. The check link of claim 1 wherein the shock absorber includes an elastic balloon configured to be compressed between the end cap and the support when the closure is in a fully open position.

11. The check link of claim 10 wherein the elastic balloon includes a vent hole therein.

12. The check link of claim 1 wherein the closure is a vehicle side door.

13. The check link of claim 1 including a second shock absorber mounted to the support and located between the end cap and the support.

14. The check link of claim 1 wherein the support includes a mounting base mounted to the other of the vehicle structure and the closure and a support housing located between the mounting base and the shock absorber.

15. A check link for a closure of a vehicle pivotally connected to vehicle structure, the check link comprising:
a main rod having a first end configured to pivotally engage one of the vehicle structure and the closure, and an opposed second end;
an end cap fixed to the opposed second end; and
a pneumatic shock absorber located between the end cap and the other of the vehicle structure and the closure, the shock absorber including an air chamber and a vent hole from the air chamber configured to control flow between the chamber and atmosphere, the shock absorber configured to resiliently absorb energy of motion of the closure when compressed.

16. The check link of claim 15 wherein the pneumatic shock absorber includes an elastic balloon having a vent hole therein.

17. The check link of claim 15 wherein the pneumatic shock absorber includes an outer air chamber cup that is fixed relative to the other of the vehicle structure and the closure, an inner member telescopically slidable in the outer air chamber cup to define an air chamber, and a spring operatively engaging the outer air chamber cup and the inner member to bias the inner member telescopically outward from the outer air chamber cup.

18. A method of absorbing energy of movement of a closure pivotable relative to a vehicle body as the closure approaches an end of movement location, the method comprising the steps of:
(a) allowing free pivoting movement over a first portion of travel of the closure;
(b) engaging a pneumatic shock absorber over a second portion of closure travel adjacent to the end of movement location;
(c) increasing air pressure in the pneumatic shock absorber over the second portion of closure travel to absorb the energy of movement of the closure; and
(d) relieving a portion of the air pressure in the pneumatic shock absorber over the second portion of travel.

19. The method of claim 18 wherein step (c) is further defined by the pneumatic shock absorber being an elastic balloon that is compressed over the second portion of closure travel, and step (d) is further defined by a vent hole in the elastic balloon that allows air flow from the elastic balloon to atmosphere.

20. The method of claim 18 wherein step (c) is further defined by the pneumatic shock absorber including an outer air chamber cup that is fixed relative to the closure, and an inner member telescopically slidable in the outer air chamber cup to define an air chamber, with the inner member pressed into the outer air chamber cup to increase the air pressure in the air chamber over the second portion of closure travel.
